(19) United States
(12) Patent Application Publication
(10) Pub. No.: US 2008/0314892 A1
(43) Pub. Date: Dec. 25, 2008

(54) RADIANT SHIELD

(76) Inventor: Robert G. Graham, Birchwood, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/768,027

(22) Filed: Jun. 25, 2007

(51) Int. Cl. F27D 11/00; F26B 3/30; G01K 1/12; G01K 7/02

(52) U.S. Cl. 219/388; 219/411; 392/411; 374/208; 374/179; 374/E01.016

(57) ABSTRACT

A radiant shield and a furnace employing a radiant shield for controlled heating and treatment of material using infrared radiation. The furnace is capable of improved temperature control where material treated by the furnace may interfere with the quality of a measured temperature signal and temperature control based on that signal.

### FIELD OF THE INVENTION

The invention is directed to a radiation shield for obscuring undesirable radiant heat sources from a temperature measuring device, and to techniques for improving performance, of temperature measuring devices in difficult environments.

### BACKGROUND OF THE INVENTION

Infrared furnaces and ovens are widely used for in a variety of industries. Materials that may be treated in an infrared furnace may include painted or coated materials that require specific curing conditions, components that require heat melt solder (i.e. ball grid arrays), pre-heating metals, circuit boards, silicon wafers treated through zone-melt processes, materials for use in photovoltaic cells requiring conductive paste to be fused thereto, and any other material that one can conceive of that is can benefit from controlled infrared radiation.

Control of the temperature within an infrared furnace may be important the quality and consistency of the products treated in such a furnace will be reduced if precise and accurate temperature control is not maintained. The high volume fabrication and treatment of heat processed or heat annealed devices entails many opportunities and challenges.

### SUMMARY OF THE INVENTION

In one embodiment in accordance with the invention, a furnace has a heat transfer zone for heating a material to be treated. A conveyor transports the material to be treated through the heat transfer zone and a radiant heat source heats the material. A thermocouple is used to measure the relative temperature within the heat transfer zone. The thermocouple is located such that at least a portion of the material to be treated passes between the radiant heat source and the thermocouple, the material to be treated intermittently obscuring the thermocouple location from the radiant heat source. A radiant shield shields the thermocouple from the radiant heat source so that the intermittently obscured radiation does not introduce noise into the measured temperature.

Another embodiment in accordance with the invention involves a method of treating material within a furnace and measuring the temperature within the furnace. The method includes the steps of placing a material to be treated on a conveyor that passes between two radiant heat sources in a heat transfer zone, heating the material to be treated, measuring the temperature within the heat transfer zone using a thermocouple located on one side of the conveyor, and obscuring the thermocouple from the heat source that is located on the other side of the conveyor with a radiant shield.

In yet another embodiment in accordance with the invention, a radiant shield and thermocouple combination usable in a continuous infrared furnace includes a mounting surface for attaching a radiant shield to a furnace wall and a radiant shield for obscuring a thermocouple from a radiant heat source. In this embodiment, the obscured radiant heat source is intermittently obscured from the thermocouple area by material to be treated passing through a furnace. This embodiment also includes a suspension element for suspending the radiant shield in a position that allows for measurement of the relative furnace temperature while obscuring the thermocouple from the obscured radiant heat source.

### BRIEF DESCRIPTION OF THE DRAWINGS

FIG. 1 is a side view of an embodiment of a furnace in accordance with the invention.

FIG. 2 is a top plan view of an embodiment of a furnace 10 in accordance with the invention.

FIG. 3 is a cross section of a top plan view of an embodiment of a radiant cooler in accordance with the invention.

FIG. 4 is a side view of an embodiment of a condenser in accordance with the invention.

FIG. 5 is an end view of an embodiment of an oven in accordance with the invention.

FIG. 6 is a perspective view of a radiant shield in accordance with embodiments of the invention.

FIG. 7 is a cross section of an end view of a furnace in accordance with embodiments of the invention.

FIG. 8 is a cross section of a radiant shield in accordance with embodiments of the invention.

FIG. 9 is a cross section of a radiant shield in accordance with embodiments of the invention.

FIG. 10 is a graphical representation of temperature control data for a furnace not employing a radiant shield in accordance with the invention.

FIG. 11 is a graphical representation of temperature control data for a furnace employing a radiant shield in accordance with the invention.

### DETAILED DESCRIPTION OF THE INVENTION

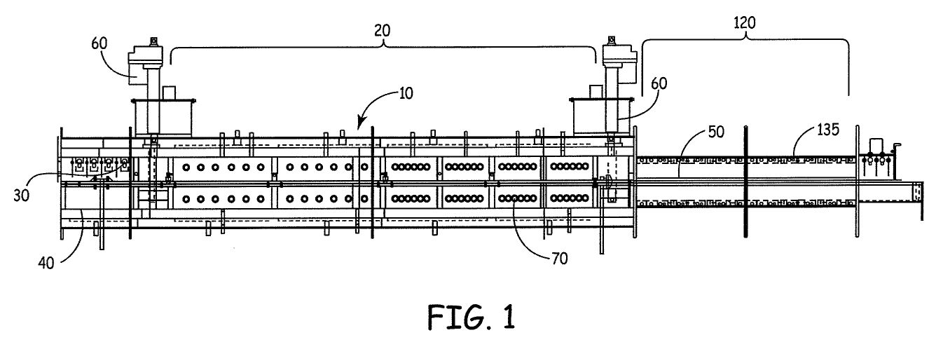

Turning now to the figures, FIG. 1 is a side view of an embodiment of a furnace in accordance with the invention. The furnace 10 has a heat transfer zone generally indicated at 20 for heating a material to be treated (not shown). The heat transfer zone 20 has an upper portion 30 and a lower portion 40. A conveyor 50 transports material to be treated through heat transfer zone 20 along a direction of travel. The conveyor 50 may be, for example, a conveyor belt, a walking beam, or other conveyor known in the art. An optional jack 60 allows movement of the lower portion 40 of the heat transfer zone 20 to allow access to the interior of the heat transfer zone 20 and to components therein. A jack 60, as used in this application, means a device for raising and lowering objects by means of force applied with a lever, screw, hydraulic press, or other means known in the art. The heat transfer zone 20 may also include one or more infrared lamps 70. These infrared lamps may be, for example, quartz, silicon carbide, or tungsten halogen lamps or any lamp known in the art. The lowering of the lower portion 40 of the heat transfer zone 20 by the jack 60 may allow, for example, for cleaning of the lower portion 40 without interference by the conveyor 50, more simple access for maintenance of other elements of the furnace 10, such as replacing lower lamps 70 or other elements of the furnace 10.

The access to the interior of the furnace 10 provided by moving the lower portion 40 of the furnace from the bottom of the furnace may allow for, among other things, maintenance or replacement of insulation, lamps, the conveyor, and other elements not easily accessible without moving the lower portion. Access to the lower portion 40 of the furnace also allows for the removal of material to be treated that has fallen from the conveyor 50, broken during processing, or otherwise collected in the lower portion 40 of the furnace.

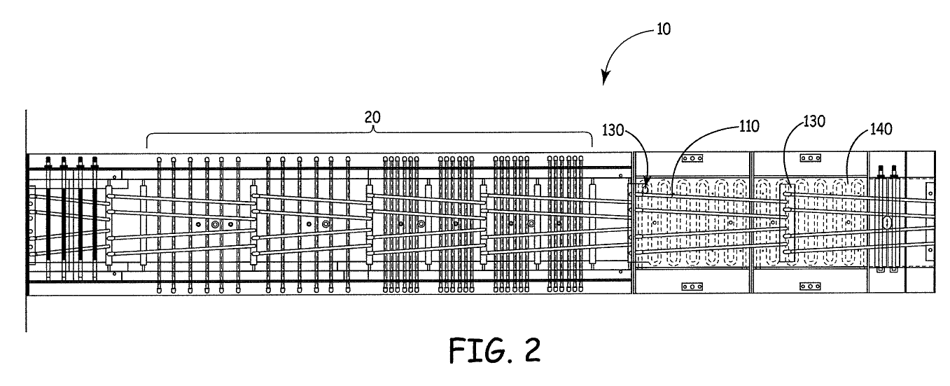

FIG. 2 is a top plan view of an embodiment of a furnace 10 in accordance with the invention. The embodiment of FIG. 2 may include conveyor supports 110 that support the conveyor 50 (shown in FIG. 1). The conveyor supports 110 may, for example, be quartz rods or other material known in the art designed to withstand the severe environment within the furnace 10.

The conveyor supports 110 shown in the embodiment in FIG. 2 span between cross supports 130. Viewing this figure from left to right, the conveyor supports 110 are oriented in a repetitive converging fashion. That is, beginning at any particular cross member 130 and moving from left to right, the conveyor supports 110 are initially further spaced from each other and converged toward each other as you move toward the next cross support 130 to the right. In the exemplary embodiment shown in FIG. 2, this pattern repeats itself through the furnace 10.

By orienting the conveyor supports 110 in this fashion it is possible to increase the uniformity of the infrared radiation reaching the work pieces from the lower infrared lamps 70. In many prior art furnaces, conveyor supports are parallel to the direction of travel of the work pieces and are between the lower infrared lamps and the work pieces. These conveyor supports interfere with radiant heat transfer to the portion of the work pieces that is “shadowed” by these conveyor supports. This can result in inconsistent heating or treatment of work pieces. By orienting the supports in a non-parallel fashion or slightly skew fashion, embodiments of a furnace in accordance with the invention allow more consistent exposure of the work pieces to the infrared lamps on the other side of the supports. One can appreciate these embodiments by picturing a work piece traveling along a conveyor over a support that is parallel to the direction of travel wherein the support casts a “shadow” on the same area of the work piece throughout the travel, whereas a support that is slightly skew will “shadow” a different portion of the work piece as the work piece moves along the conveyor in the direction of travel. The supports could also be oriented in, for example, a herringbone, zigzag, repetitive diverging, or other orientation. Other orientations of conveyor supports 110 that will achieve this goal will occur to those skilled in the art upon reading this disclosure and are contemplated by this disclosure and the appended claims.

Embodiments of a furnace in accordance with this invention may also include a cooling zone generally indicated at 120. Cooling zone 120 may include a radiant cooler 135 to allow removal of heat from the work pieces.

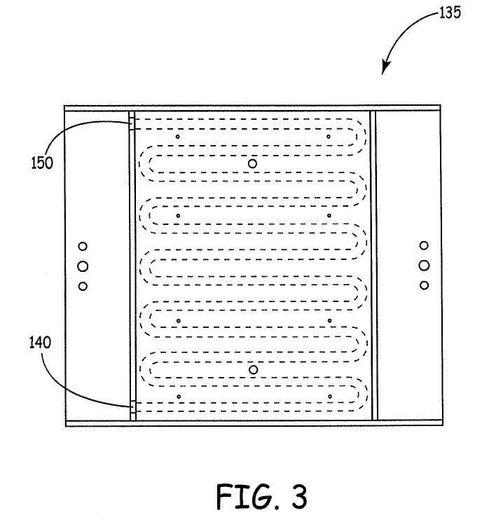

FIG. 3 is a cross section of a top plan view of an embodiment of a radiant cooler in accordance with the invention. The radiant cooler 135 has an inlet 140 and outlet 150 to allow a cooling medium to pass through the body of the radiant cooler 135. The radiant cooler 135 may be made of any material and may be coated with a non-reflective coating to enhance radiant heat transfer from the material to be treated to the radiant cooler. In one exemplary embodiment of the invention, the radiant cooler is made of aluminum and is black anodized to enhance heat transfer.

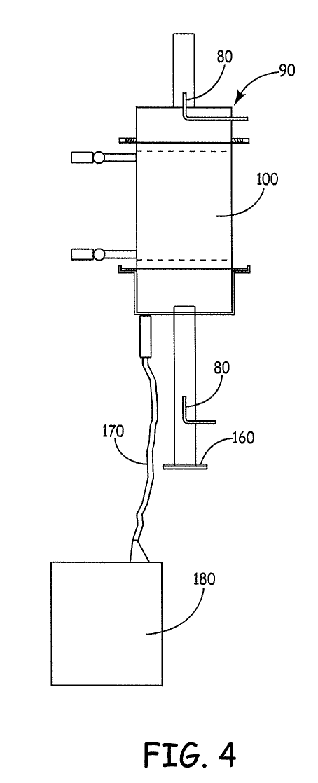

FIG. 4 is a side view of an embodiment of a condenser in accordance with the invention. Some embodiments of a furnace 10 in accordance with this invention may also include a condenser 90 having an air mover 80 and a heat transfer element 100. The air mover 80 may be a fan, an eductor, or any device known in the art. The condenser 90 may, for example, be mounted on the furnace 10 (not shown) using a flange 160. The air mover 80 may draw air through the furnace 10 to create a slight negative pressure within the furnace. The furnace may contain a controlled or inert atmosphere or simply ambient air. A controlled atmosphere that may be contained within the furnace may include a low or high oxygen atmosphere, a controlled humidity atmosphere, an atmosphere rich in any relevant gas or vapor, or other such atmosphere as may be required based on specific processing applications. Volatile materials driven from the work pieces are drawn through the air mover 80 into the condenser 90 so that, as possible, they may be condensed and recovered rather than released to the atmosphere. The condensed material may drain from the condenser 90 through a drain line 170 to a collection vessel 180. In some embodiments, the condenser 90 has a heat transfer element 100 which may be removed from the condenser 90 for cleaning, maintenance, or replacement.

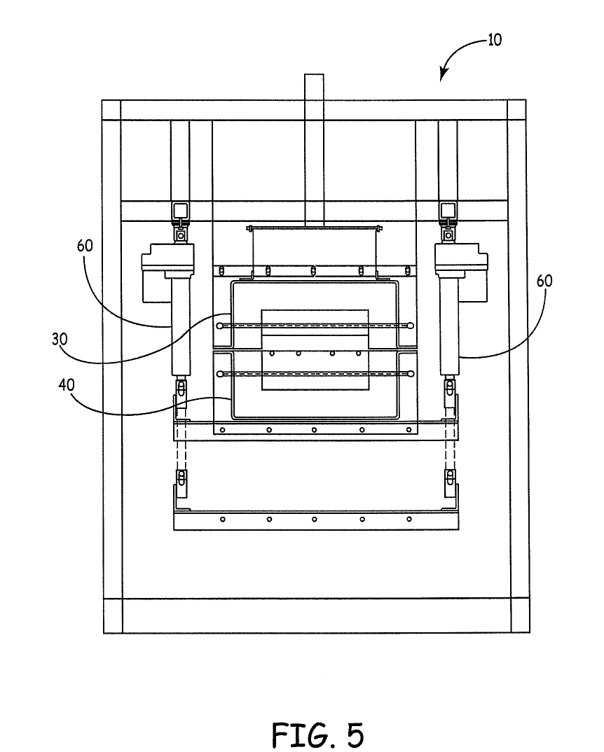

FIG. 5 is an end view of an embodiment of an oven in accordance with the invention. The furnace 10 of FIG. 5 has an upper portion 30 and a lower portion 40. Jacks 60 allow for the lowering of the lower portion 40 to provide access to the interior of the furnace 10. The access to the interior of the furnace 10 provided by moving the lower portion 40 of the furnace from the bottom of the furnace may allow for, among other things, maintenance or replacement of insulation, lamps, the conveyor, and other elements not easily accessible without moving the lower portion. Access to the lower portion 40 of the furnace also allows for the removal of material to be treated that has fallen from the conveyor, broken during processing, or otherwise collected in the lower portion 40 of the furnace.

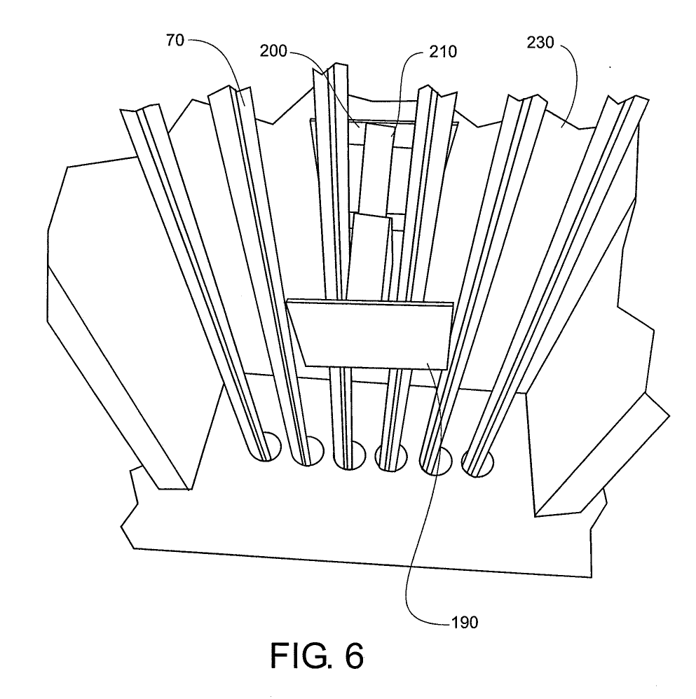

FIG. 6 is a perspective view of a radiant shield in accordance with embodiments of the invention. The radiant shield 190 of this embodiment happens to be located proximate the upper portion 30 of a furnace 10. A thermocouple 220 (not shown) is mounted so that the tip is located between the radiant shield 190 and the wall of the furnace 230. The infrared lamps 70 in the upper portion 30 of the furnace are exposed to the thermocouple 220, but the radiant shield 190 largely obscures the thermocouple 220 from the infrared lamps of the lower portion 40 of the furnace 10 (described above).

When the furnace 10 is employed to heat treat material, the material to be treated passes through the furnace 10 on a conveyor 50 as described above. The material is may be placed on the conveyor 50 with spaces between the individual pieces of material. If there were no radiant shield in place, the material passing through the furnace on the conveyor 50 would intermittently obscure the lamps 70 in the lower portion of the furnace from the thermocouple 220 located in the upper portion 30 of the furnace 10. Depending on its construction, the conveyor 50 itself may intermittently cast “shadows” or otherwise obscure the lamps 70 in the lower portion 40 of the furnace 10 from the thermocouple 220. Of course, the thermocouple 220 could be located in the bottom portion 40 of the furnace 10 and the shield 190 would act in the same way to avoid intermittent radiant input to the thermocouple from the lamps 70 in the top portion of the furnace 10. In fact, embodiments of the invention apply wherever a undesirable radiant heat source interferes with temperature measurement.

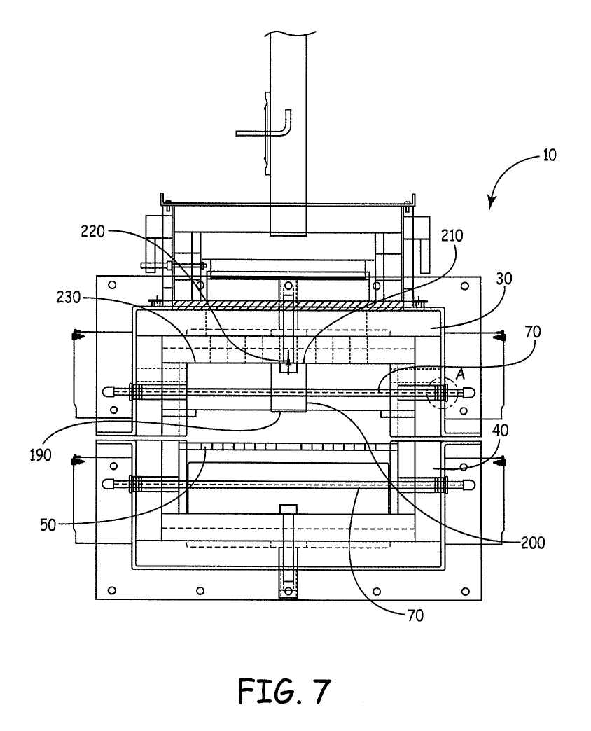

FIG. 7 is a cross section of an end view of a furnace in accordance with embodiments of the invention. Furnace 10 has an upper portion 30 and a lower portion 40. There are banks of infrared lamps 70 in the upper portion 30 and the lower portion 40. Conveyor 50 transports material to be treated through the furnace 10 between the upper and lower banks of lamps 70. The thermocouple 220 is located proximate the upper bank of lamps. The radiant shield 190 is oriented so that is obscures the thermocouple 220 from the lower bank of lamps. A suspension element 200 connects the radiant shield 190 to the mounting surface 210. The suspension element may be designed to fit between lamps 70 so that not lamps have to be removed to accommodate the radiant shield. Of course, other designs will fall within the scope of the appended claims.

The mounting surface 210 is secured to the furnace wall 230 of this embodiment in away that allows the thermocouple 220 to be mounted so that the sensing portion of the thermocouple is positioned as to be generally obscured for the bank of lamps 70 in the lower portion 40 of the furnace 10. In one embodiment of the invention the radiant shield 190 is a flat piece of metal measuring approximately two inches by two inches square and is mounted approximately ⅛″ below the tip of a vertically sheathed thermocouple. This prevents or minimizes direct line-of-sight exposure to the lower bank of lamps 70 and the resultant fluctuations in measured temperature that otherwise occur when the lower bank of lamps 70 is intermittently blocked. The reduction of these sudden changes in the amount of energy that the thermocouple is receiving allows for improved monitoring and control of furnace conditions.

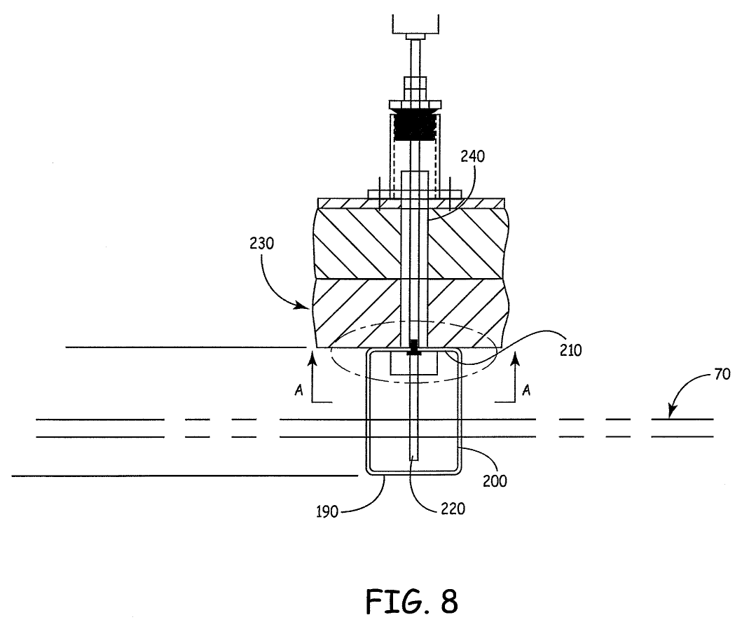

FIG. 8 is a cross section of a radiant shield in accordance with embodiments of the invention. The thermocouple 220 is installed such that it extends through the furnace wall 230. A hole is formed in the furnace wall 230 and an optional sheath 240 is placed within the hole. The sheath 240 could be connected to the radiant shield 190 and installed from the inside of the furnace if the adjacent lamps 70 have been temporarily removed. The sheath 240 could be a ceramic tube or other protective sheath as will occur to those of skill in the art. The thermocouple 220 is then installed within the sheath. As already described the radiant shield mounting surface 210 is secured to the furnace wall 230 in such a way as to allow the thermocouple to extend into the furnace. In this embodiment, the furnace wall 230 comprises two layers of duraboard insulation and a metal jacketing. The thermocouple 220 may be secured to the metal jacketing and hang free into the furnace. Adhesives, fasteners, and sealants known in the art could be used alone or in combination to construct embodiments in accordance with the invention.

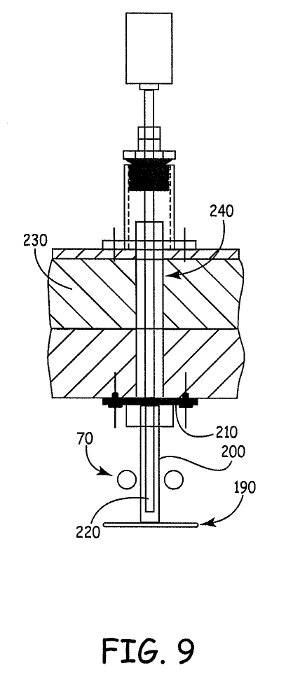

FIG. 9 is a cross section of a radiant shield in accordance with embodiments of the invention. The view of FIG. 9 is taken at a perpendicular angle to the view of FIG. 8. In this view one can see how the radiant shield 190 is positioned to obscure the thermocouple 220 from the lower bank of lamps (not shown) while not requiring the permanent removal of any of the upper bank of lamps 70 by use of an appropriately designed suspension member 200. The sheath 240 is positioned to create a passage through the wall 230 through which the thermocouple 220 may be installed.

The environment within an infrared furnace may be severe, so appropriate materials of construction should be used when constructing shield in accordance with the invention. Also, the material of the shield should be selected so that the emissivity of the shield remains relatively constant throughout the life of the shield. If the emissivity of the shield changes as the shield ages or is exposed to the furnace environment, the temperature measurement of the thermocouple may become skewed over time. While not required, it is considered preferable to avoid this type of skewing to the extent possible.

In one embodiment, the shield is formed of metal and coated with a high performance coating such as VHT FlameProof very high temperature ceramic base silicon coatings. It has been learned that the flat black coating with part #SP-102 performs well in many applications.

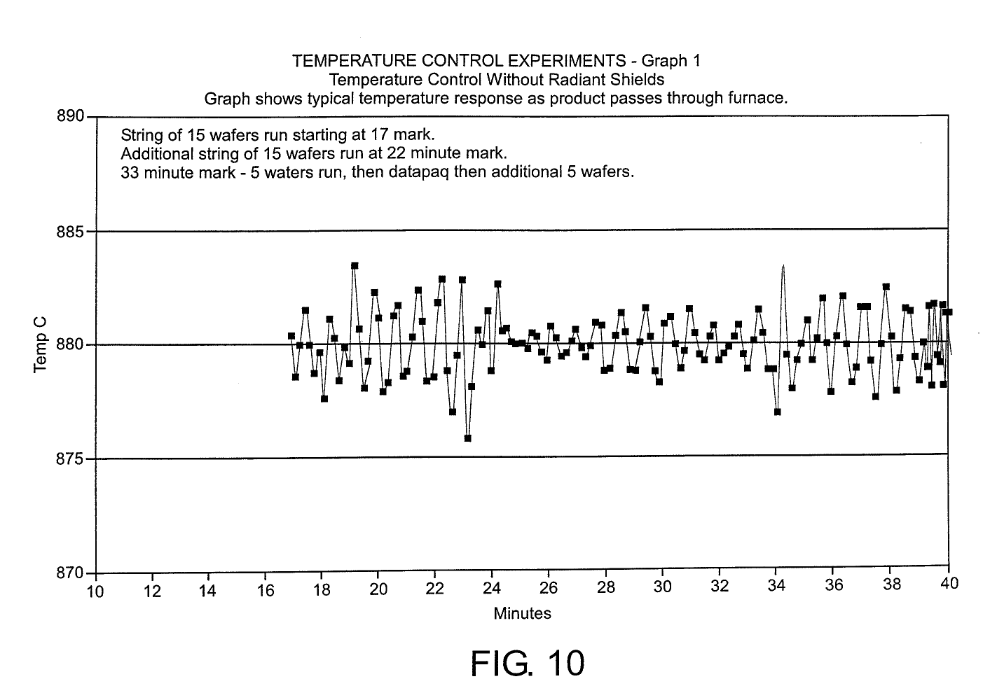

FIG. 10 is a graphical representation of temperature control data for a furnace not employing a radiant shield in accordance with the invention. The data in FIG. 10 is for a continuous infrared furnace treating material that passes though the furnace on a conveyor. The furnace has a bank of infrared lamps above the conveyor and another bank below the conveyor. An unshielded thermocouple is located proximate the upper bank of infrared lamps. Energy input into the furnace is controlled by reading the temperature measured by the thermocouple and adjusting the energy input to the lamps based on the measured temperature relative to the set point of 880° C. As material to be treated, in this case wafers, pass through the furnace, the intermittent shadowing of the thermocouple relative to the lower bank of bulbs by the material to be treated results in “noise” in the measured temperature. The noise in the measured temperature causes deviations from the setpoint as the temperature controller responds to the intermittent shadowing of the thermocouple.

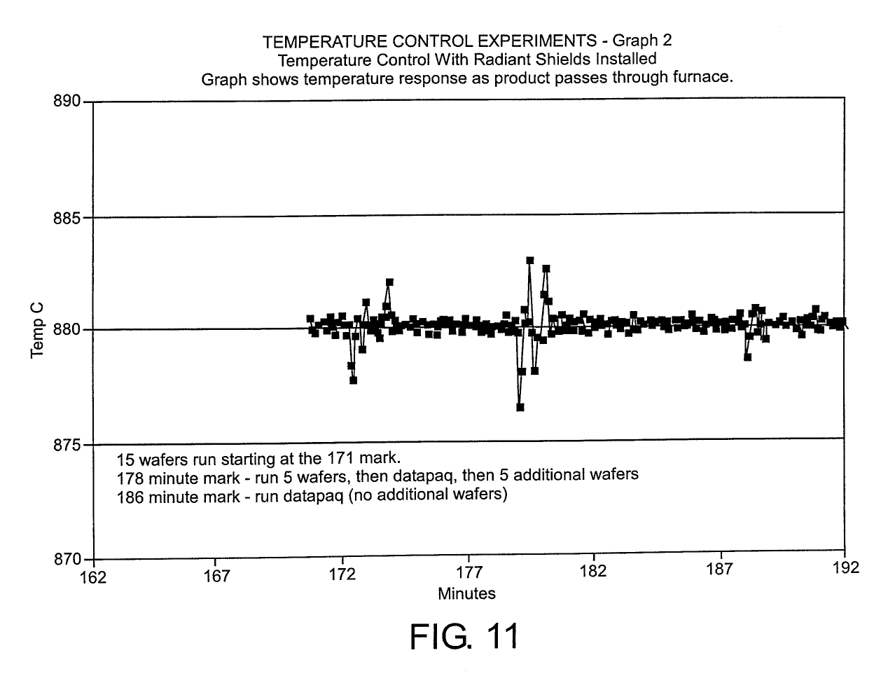

FIG. 11 is a graphical representation of temperature control data for a furnace employing a radiant shield in accordance with the invention. FIG. 11 shows temperature data from the same furnace and control system used in generating the data shown in FIG. 10, except that the furnace in FIG. 11 employs a radiant shield in accordance with the invention. The deviations from the setpoint are dramatically reduced because the thermocouple is shielded from the lower bank of bulbs that provided the thermocouple of the system in FIG. 10 with intermittent radiation inputs. The improved control allows for the production of more consistent products from the furnace, reducing off-spec product and associated waste.

While exemplary embodiments of this invention have been illustrated and described, it should be understood that various changes, adaptations, and modifications may be made therein without departing from the spirit of the invention and the scope of the appended claims.

What is claimed is:

1. A furnace comprising
a. a heat transfer zone for heating a material to be treated;
b. a conveyor that transports material to be treated through the heat transfer zone along a direction of travel;
c. a radiant heat source for heating the material to be treated;
d. a thermocouple for measuring the relative temperature within the heat transfer zone, the thermocouple located such that at least a portion of the material to be treated passes between the radiant heat source and the thermocouple, the material to be treated intermittently obscuring the thermocouple location from the radiant heat source; and
e. a radiant shield that shields the thermocouple from the radiant heat source so that the intermittently obscured radiation does not introduce noise into the measured temperature.

2. The furnace of claim 1, wherein the heat transfer zone contains infrared lamps.

3. The furnace of claim 2, wherein the infrared lamps are selected from a group consisting of quartz lamps, silicon carbide lamps, and tungsten halogen lamps.

4. The furnace of claim 1, wherein the radiant shield is coated with a surface coating.

5. The furnace of claim 4, wherein the emissivity level of the coated radiant shield is >0.95.

6. The furnace of claim 1, wherein the thermocouple is an open tip thermocouple.

7. The furnace of claim 1, wherein the radiant shield is anodized.

8. The furnace of claim 1, wherein the conveyor is oriented between two banks of infrared lamps and the thermocouple and radiant shield are located so that the thermocouple is exposed to the bank of lamps nearest the thermocouple and obscured from the other bank of lamps by the radiant shield.

9. The furnace of claim 8, wherein one of the two banks is above the conveyor and the other is below the conveyor and the thermocouple is located proximate the upper bank and the radiant shield obscures the thermocouple from the lower bank.

10. A method of treating material within a furnace and measuring the temperature within the furnace comprising:
a. placing a material to be treated on a conveyor that passes between two radiant heat sources in a heat transfer zone;
b. heating the material to be treated;
c. measuring the temperature within the heat transfer zone using a thermocouple located on one side of the conveyor; and
d. obscuring the thermocouple from the heat source that is located on the other side of the conveyor with a radiant shield.

11. The method of claim 10, wherein the radiant heat sources are infrared heat lamps.

12. The method of claim 11, wherein the infrared lamps are selected from a group consisting of quartz lamps, silicon carbide lamps, and tungsten halogen lamps.

13. The method of claim 10, wherein the material to be treated comprises silicon wafers.

14. The method of claim 10, wherein a first of the two radiant heat sources is located below the conveyor and a second of the two radiant heat sources is located above the conveyor and the thermocouple is located proximate the second radiant heat source and the radiant shield obscures the thermocouple from the first radiant heat source.

15. A radiant shield and thermocouple combination for use in a continuous infrared furnace, the combination comprising:
a. a mounting surface for attaching a radiant shield to a furnace wall;
b. a radiant shield for obscuring a thermocouple from a radiant heat source, the obscured radiant heat source being intermittently obscured from the thermocouple area by material to be treated passing through a furnace; and
c. a suspension element for suspending the radiant shield in a position that allows for measurement of the relative furnace temperature while obscuring the thermocouple from the obscured radiant heat source.

16. The combination of claim 15, wherein the radiant shield is coated.

17. The combination of claim 15, wherein the suspension element comprises a pillar that is generally perpendicular to the radiant shield.

18. The combination of claim 17, wherein the suspension element is designed to fit between infrared lamps located proximate the thermocouple and shield.
